(19) United States
(12) Patent Application Publication
(10) Pub. No.: US 2007/0016364 A1
(43) Pub. Date: Jan. 18, 2007

(54) System and method for identifying position information of vehicle

(76) Inventors: Mi-Hyun Lee, Gimpo-si (KR); Eun-Kyung Go, Seoul-si (KR)

Correspondence Address: SHERMAN D PERNIA, ESQ., PC, 1110 NASA ROAD ONE, SUITE 450, HOUSTON, TX, 77058-3310, US

(21) Appl. No.: 11/202,622

(22) Filed: Aug. 13, 2005

(30) Foreign Application Priority Data
Jul. 13, 2005 (KR) 10-2005-0063138

(51) Int. Cl. G01C 21/00

(52) U.S. Cl. 701/207

(57) ABSTRACT

A system and method for identifying parking position information is provided. The system includes a plurality of household equipments for displaying parking position information and vehicle unparking information; a home network management server for notifying the household equipments of the parking position and unparking information; an entrance reader for recognizing a first card; an exit reader for recognizing the first card; a parking position card reader for transmitting the parking position and driver information; a parking management server for transmitting the received parking position and driver information; a Web server for receiving the parking position and driver information; and the SMS generation and transmission server for displaying a message relating to the parking position and driver information.

### BACKGROUND OF THE INVENTION

1. Field of the Invention

The present invention relates to a system and method for identifying parking position information, and more particularly, to a system and method for identifying parking position information, where vehicle co-owners (that is, plural persons) can identify a parking position of a vehicle, which is parked at a parking lot of a collective building (multi-family house or residential development building), or vehicle entrance/unparking information, through a household equipment or mobile wireless terminal provided in a household.

2. Description of the Related Art

Today, as cars are remarkably increased in number, large-sized parking lots are much provided at a collective building such as an airport, a grand shopping center, a grand recreational facility, and a grand multi-family house. Accordingly, after a driver parks a vehicle at the collective building, he/she memorizes or notes a parking area number on a separate scratch paper. However, the driver frequently gets into difficulty due to the loss of the scratch paper or the inexact memory of the parking area number.

Further, in recent years, a grand complex multi-house house is being built to have a grand basement parking lot, and drivers being family constituents co-owning and driving one vehicle are being increased in number. However, due to a vehicle working-free system resulting from the increase of the number of vehicles, and a vehicle working limit resulting from the advent of the age of a high oil price, the family constituents of the multi-family house or apartment are sincerely requiring parking position information. In other words, after any one of the family constituents drives, he/she should have performed a conventional information confirmation procedure for a parking position, that is, he/she should have memorized or noted a parking area of the parking lot on the scratch paper to inform other family constituents.

Further, when a vehicle theft accident occurs at the basement parking lot, it cannot be identified whether or not the stolen vehicle has been unparked outside from a development and therefore, it cannot be identified whether the stolen vehicle actually remains within the development or is in course of unparking outside from the development. In a present method, after the occurrence of the theft accident, a record screen of a CCTV (Closed Circuit TV) installed at the basement parking lot is inspected, thereby checking whether the stolen vehicle has been unparked any time.

Unlike the multi-family apartment, in a grand discount mart, a department store, and a hotel, a number ticket, a parking permit and the like are issued to notify unspecified persons using the parking lot of a parking position, but even in this method, only the driver can identify the parking position, and there is a danger of losing an information object having position information, and it is a present reality that one person just merely identifies the parking position.

Further, in a conventional vehicle entrance control system of the multi-family house, it is possible to control only the entry of an outside vehicle into the multi-family house development, and there is not a technology relating to vehicle position information and anti-theft.

In some shopping centers and grand parking lots, in case where only the vehicle driver desires to be aware of parking information, by identifying the parking position using a sensor, and identifying the parking position by the sensing of a card within a parking area, thereby detecting only the parking position, the driver cannot aware of the parking information until the card is read at a designated place at the time of an initial parking, thereby causing a spatial and temporal limit.

Meantime, in Korean Patent publication no. 10200200018781, after a vehicle registration number and a parking position are sensed in a parking sensing unit installed at a parking lot, the sensed vehicle registration number and parking position information is wire and wireless transmitted and applied to a parking control server through a communication network. The parking control server transmits parking position, registration number, parking fee data to the vehicle database through Internet network. The vehicle database outputs a mobile terminal phone number, and the parking position and parking fee data corresponding to the vehicle registration number, transmits to the mobile communication network, and display on the mobile terminal.

In the above conventional art, the parking position and the parking fee can be displayed on the mobile terminal, thereby notifying the driver of the parking position information of the parked vehicle, but each of co-owners using the vehicle at the multi-family house cannot recognize parking position information on the vehicle parked, entrance information on the vehicle entered into the parking lot, or unparking information on the vehicle unparked from the parking lot. In other words, in the conventional art, one driver can be identify the parking position information, but the co-owners co-owning the vehicle cannot recognize whether the vehicle is parked anywhere and whether any one unparks the vehicle outside from the parking lot when they themselves do not drive the vehicle.

### SUMMARY OF THE INVENTION

Accordingly, the present invention is directed to a system and method for identifying position information of a vehicle that substantially overcomes one or more of the limitations and disadvantages of the conventional art.

One object of the present invention is to provide a system and method for identifying position information of a vehicle, where vehicle co-owners can all recognize parking position and entrance/unparking information of a vehicle, through a household equipment or a mobile wireless terminal provided in a household.

Another object of the present invention is to provide a system and method for identifying position information of a vehicle, where when a driver, not a vehicle co-owner, unparks a vehicle, the vehicle co-owner can be notified of vehicle unparking information, thereby preventing a theft accident.

A further another object of the present invention is to provide a system and method for identifying position information of a vehicle, where when the vehicle enters a parking lot, vehicle co-owners is notified of vehicle entrance information through their mobile wireless terminals.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims as well as the appended drawings.

To achieve the above and other objects and advantages, and in accordance with the purpose of the invention, as embodied and broadly described herein, there is provided a system for identifying vehicle position information, the system including: a plurality of household equipments for, when a vehicle enters a multi-family house development and parks at a parking lot, displaying parking position information, and when the parked vehicle is unparked outside from the multi-family house development, displaying vehicle unparking information; a home network management server connected with the plurality of household equipments, and notifying the plurality of household equipments of the parking position information and the unparking information of the parked vehicle; an entrance reader for, when the vehicle enters, recognizing a first card disposed in the vehicle; an exit reader for, when the vehicle is unparked, recognizing the first card disposed in the vehicle; a parking position card reader installed at each parking area, which is sectioned in plural, of the parking lot, and when a driver approaches or contacts his/her possessing second card, reading information from the second card and transmitting the parking position information and driver information from the vehicle; a parking management server for receiving first card read information from the entrance reader, receiving the parking position information and the driver information of the corresponding vehicle from the parking position card reader installed at a corresponding parking area, and transmitting the received parking position information and driver information to the home network management server or a SMS (Short Message Service) generation and transmission server; a Web server connected to the parking management server, and receiving the parking position and driver information from the parking management server and generating SMS data; and the SMS generation and transmission server connected with the Web server, and when it is requested to send the SMS data, transmitting and displaying a message relating to the parking position and driver information, on each mobile wireless terminal of the vehicle co-owners.

In another aspect of the present invention, there is provided a system for identifying parking position information, the system including: an entrance or exit reader for recognizing a first card installed at the vehicle when the vehicle is entered or unparked; a parking management server for receiving entrance or unparking read information of the first card from the entrance or exit reader; and a SMS generation and transmission server for receiving the entrance information or the unparking information from the parking management server, generating a SMS (Short Message Service) message of the received entrance or unparking information, and transmitting and displaying the message on each previously registered mobile wireless terminal of vehicle co-owners through a communication network.

In a further another aspect of the present invention, there is provided a system for identifying parking position information, the system including: an entrance reader for, when a vehicle enters, recognizing a first card disposed in the vehicle; an exit reader for, when the vehicle is unparked, recognizing the first card disposed in the vehicle; a parking position card reader installed at each parking area, which is sectioned in plural, of the parking lot, and reading information from a driver's possessing second card and transmitting parking position information and driver information from the vehicle; a parking management server for receiving card read information from the entrance reader, receiving the parking position information and the driver information read from the parking position card reader, transmitting the received parking position information and driver information to the a SMS (Short Message Service) generation and transmission server, receiving the card read information from the exit reader, and when the vehicle is unparked outside from the parking lot, transmitting the unparking information to the SMS generation and transmission server; and the SMS generation and transmission server for generating a SMS message of the parking position information and the unparking information under the control of the parking management server, and transmitting and displaying the SMS message on each mobile wireless terminal of the vehicle co-owners.

The system further may include: an entrance gate installed at an entrance of a parking lot, and controlling the entrance of the vehicle using a predetermined control signal; an exit gate installed at an exit of the parking lot, and controlling the unparking of the vehicle using a predetermined control signal; and a parking management terminal connected to the parking management server, and registering information on a vehicle registration number, a sex, a name, and a street address of each household and storing the registered information in the second card.

The second card is a proximity RF (Radio Frequency) card, a magnetic card, an IC (Integrated Circuit) card, or a tag card.

In a still another aspect of the present invention, there is provided a method for identifying vehicle position information, the method including the steps of: when a vehicle enters, reading vehicle relation information from a first card installed at the vehicle; reading vehicle relation information and parking position information from second cards provided for multi-family house vehicle co-owners; generating a message of vehicle parking position and driver information in response to the vehicle relation information; and transmitting and displaying the generated message on a household equipment of a home network management server installed at a multi-family house.

In a still further another aspect of the present invention, there is provided a method for identifying vehicle position information, the method including the steps of: when a vehicle enters, reading vehicle relation information from a first card installed at the vehicle; when a driver completes to park the vehicle at a parking area of a parking lot, and approaches or contacts a second card provided for multi-family house vehicle co-owners, with a parking position card reader, reading parking position information and driver information; and transmitting a message of the parking position information and the driver information to a mobile communication provider system, and transmitting a message for identifying a UMS (Unified Message Switch) or a multimedia message for a vehicle position, to each mobile communication terminal of the vehicle co-owners.

It is to be understood that both the foregoing summary and the following detailed description of the present invention are merely exemplary and intended for explanatory purposes only.

### BRIEF DESCRIPTION OF THE DRAWINGS

The accompanying drawings, which are included to aid in understanding the invention and are incorporated into and constitute a part of this application, illustrate embodiment(s) of the invention and together with the description serve to explain the principles of the invention. In the drawings:

FIG. 1 illustrates a schematic construction of a parking management system according to an embodiment of the present invention;

FIG. 2 is a control flowchart of a parking management server of FIG. 1;

FIG. 3 is a control flowchart of a home network management server of FIG. 1; and

FIG. 4 is an example of a message displayed on a household equipment and a mobile wireless terminal when a vehicle is entered/unparked and parked.

### DETAILED DESCRIPTION OF THE INVENTION

Reference will now be made in detail to the preferred embodiments of the present invention, examples of which are illustrated in the accompanying drawings. Wherever possible, the same reference numerals will be used throughout the drawings to refer to the same or like parts.

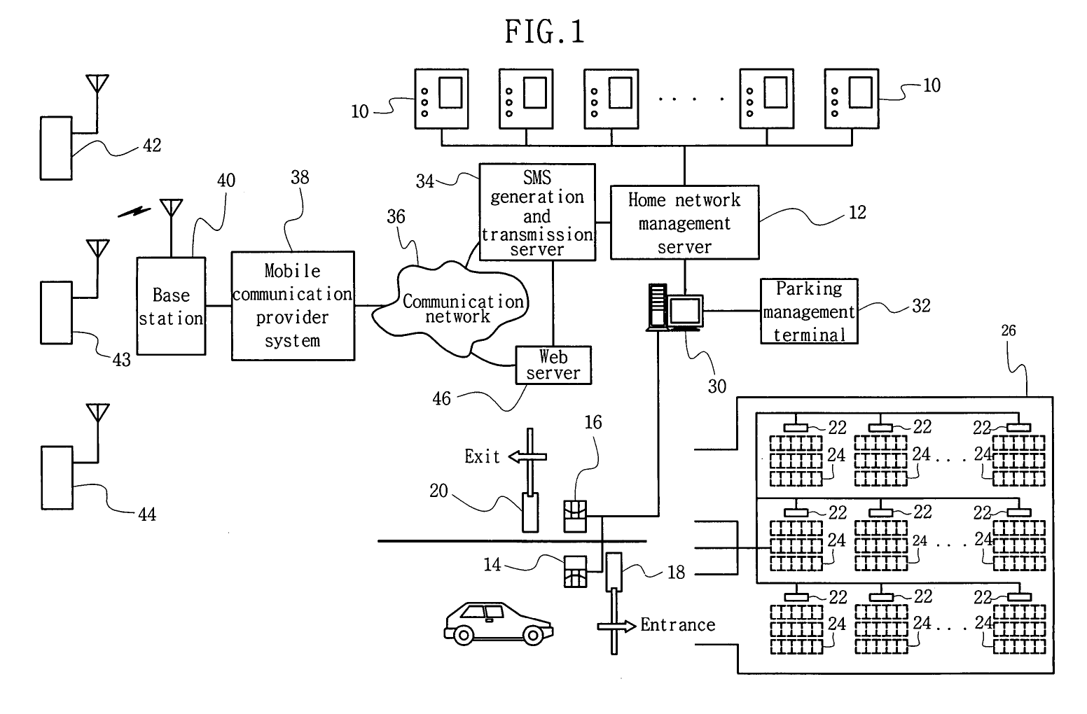

FIG. 1 illustrates a schematic construction of a parking management system according to an embodiment of the present invention.

The inventive parking management system includes a plurality of household equipments 10, a home network management server 12, an entrance reader 14, an exit reader 16, an entrance gate 18, an exit gate 20, a parking position card reader 22, a parking management server 30, a parking management terminal 32, a Web server 46, a Short Message Service (SMS) generation and transmission server 34, a mobile communication provider system 38, and a base station 40.

The household equipment 10 having buttons is installed at each household of a collective building, and identifies a position of a parked vehicle. When the vehicle is entered and parked in a multi-family house development, the household equipment 10 displays parking position information and driver information, and when the parked vehicle is unparked outside from the multi-family house development, it displays vehicle unparking information.

The home network management server 12 is connected with the plurality of household equipments 10, and notifies the plurality of household equipments 10 of the parking position information and driver information and the unparking information of the parked vehicle.

When the vehicle is entered, the entrance reader 14 recognizes a first card disposed in the vehicle.

When the vehicle is unparked, the exit reader 16 recognizes the first card.

The entrance gate 18 is installed at an entrance of a parking lot, and controls the entrance of the vehicle using a predetermined control signal.

The exit gate 20 is installed at an exit of the parking lot, and controls the unparking of the vehicle using a predetermined control signal.

The parking position card reader 22 is installed at each parking area 24, which is sectioned in plural, within the parking lot 26, and reads a driver's second card and transmits the parking position information.

The parking management server 30 receives card read information from the entrance and exit readers 14 and 16, and opens the entrance and exit gates 18 and 20.

When the driver completes the parking at the sectioned parking area 24 of the parking lot, and approaches or contacts the second card with the parking position card reader 22 installed at a corresponding parking area 24, the parking management server 30 receives the parking position information and the driver information of the corresponding vehicle, and transmits the received information to the home network management server 12 and the SMS generation and transmission server 34.

The parking management server 30 receives first card read information from the entrance reader 14. When not receiving second card read signal form the parking position card reader 22 during a predetermined time, the parking management server 30 transmits the vehicle entrance information to the SMS generation and transmission server 34.

The parking management terminal 32 is connected to the parking management server 30, and registers information on a vehicle registration number, a sex, a name, a street address, and a mobile wireless terminal number of each household, and stores the registered information in the second card.

When the vehicle is entered, unparked, or parked, the Web server 46 receives entrance/unparking and parking information from the parking management server 30 and generates short message data relating to vehicle position or driver information.

The SMS generation and transmission server 34 receives the parking position information and unparking information of the vehicle and a SMS, through the communication network 36.

The mobile communication provider system 38 receives the SMS message through the communication network 36 and transmits the received SMS message to the base station 40.

The base station 40 transmits the SMS message from the mobile communication provider system 38 to the mobile communication terminals 42, 43 and 44.

The information on the vehicle registration number, the sex, the name, the street address, and the mobile wireless terminal number of each household is stored in a database provided at the parking management server 30, but can be also stored in a database built in the home network management server 12.

The second card can employ a proximity Radio Frequency (RF) card or magnetic card, an Integrated Circuit (IC) card, or a tag card, for example.

The first card can employ a long distance RF car, a proximity RF card, or a magnetic card, a tag car, or an IC card, and is provided for the vehicle. For example, in case where the first card employs the long distance RF card, when the vehicle enters the entrance or the exit of the parking lot, the entrance and exit readers 14 and 16 read information from the long distance RF card of the vehicle, and transmits the read information to the parking management server 30, thereby opening the entrance gage 18 and the exit gate 20.

The household equipment 10 can be a videophone, wall pad, or the like, for example.

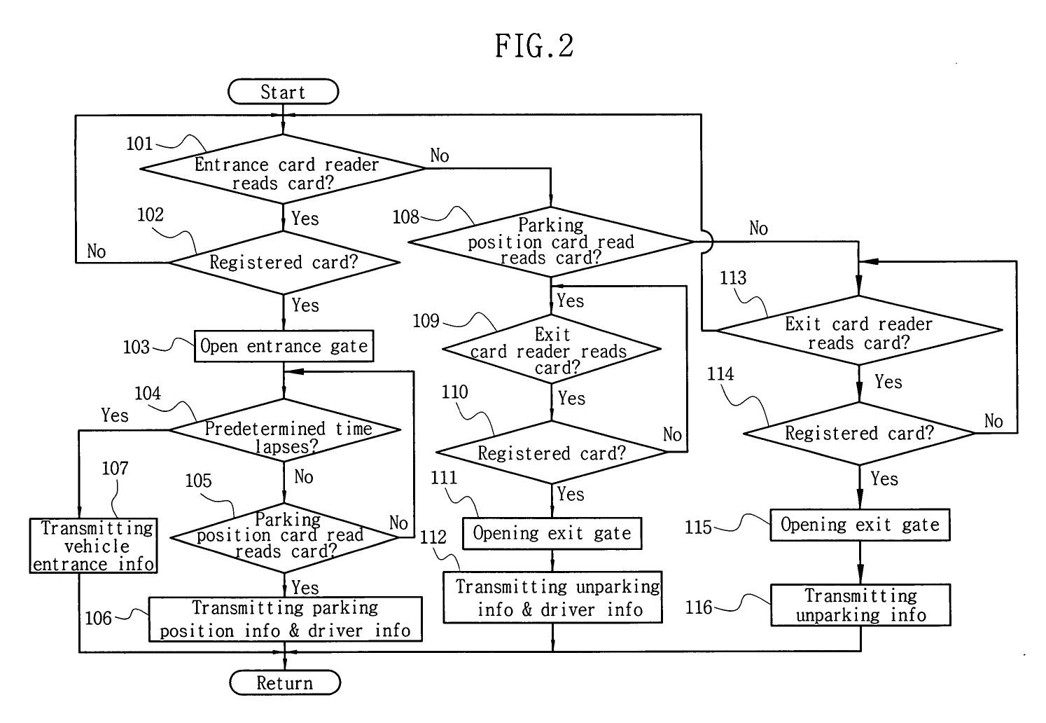

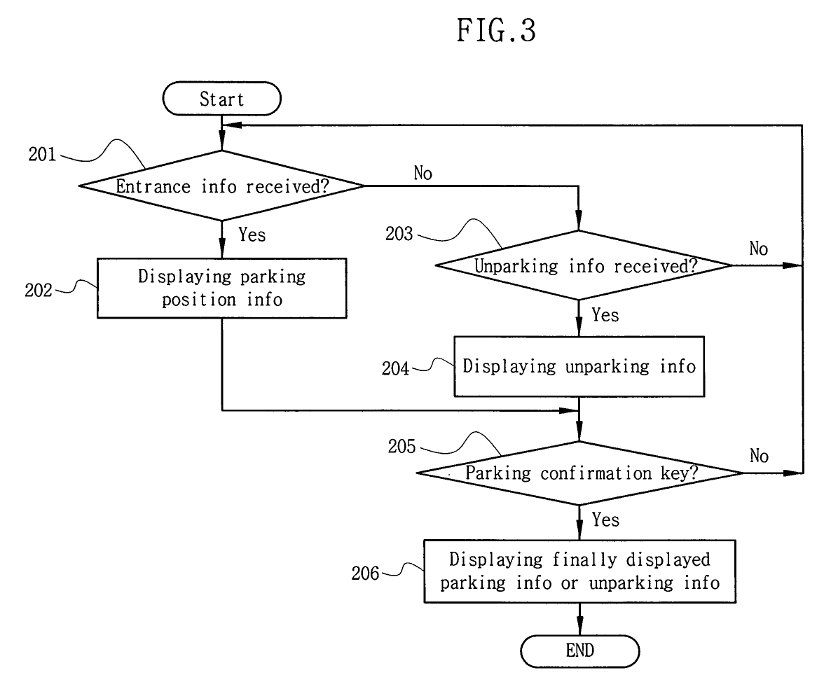

FIG. 2 is a control flowchart of the parking management server 30 of FIG. 1, and FIG. 3 is a control flowchart of the home network management server 12 of FIG. 1.

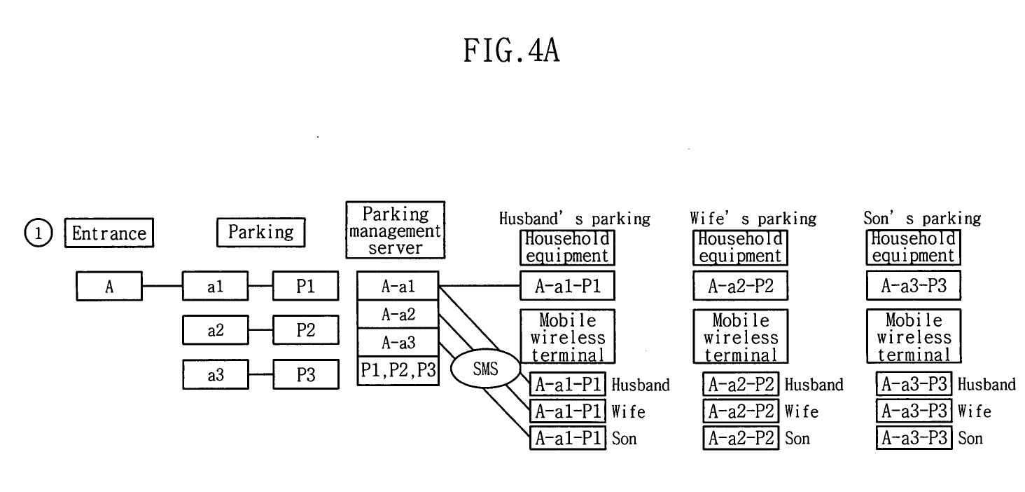

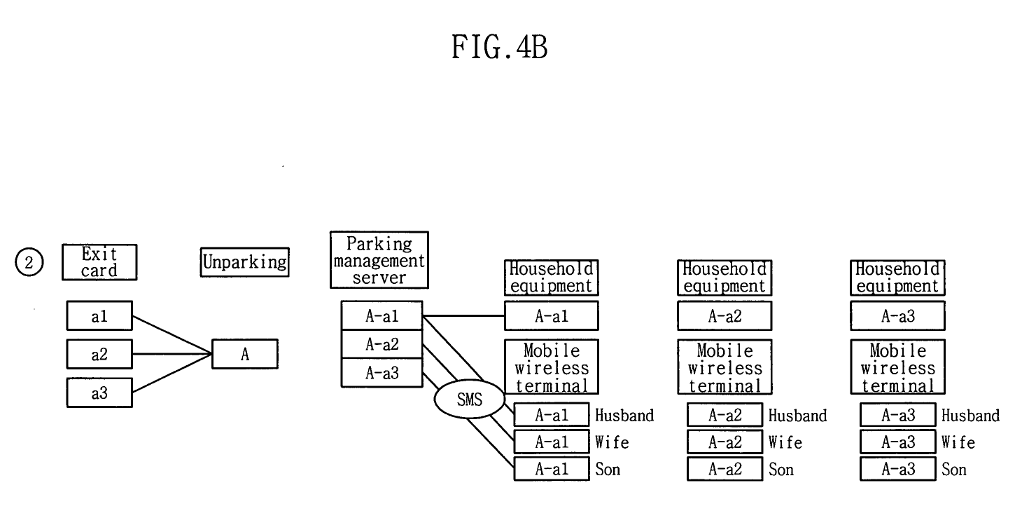

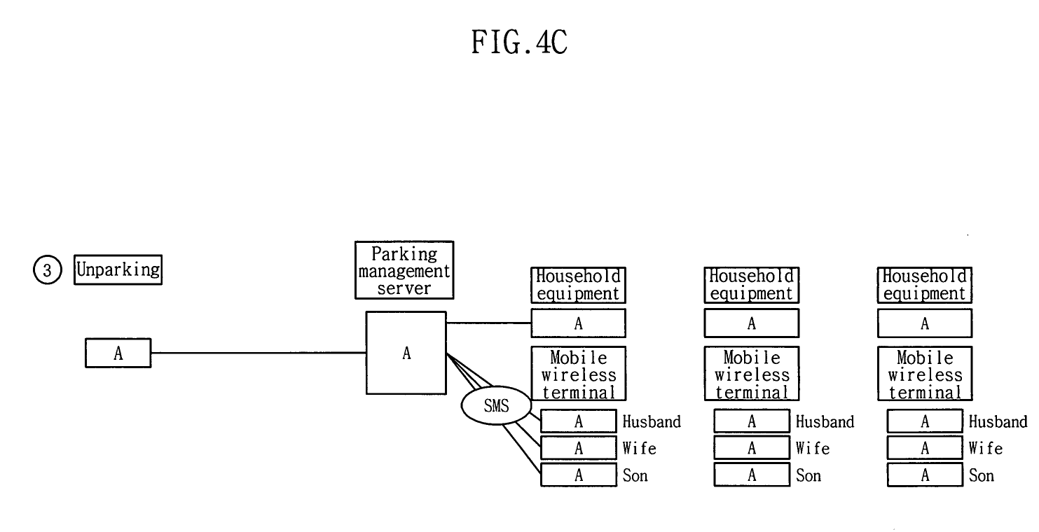

FIG. 4 is an example of a message displayed on the household equipment 10 and the mobile wireless terminals 42, 43 and 44 when the vehicle is entered/unparked and parked.

An operation of the parking management system according to a preferred embodiment of the present invention will be in detail described with reference to FIGS. 1 to 4.

According to the present invention, in a residentable building such as a multi-family house or a residential and commercial development, the first card can be used as a per-household vehicle passing card, and the second card can be provided for each per-household family constituent and used for both the identifying of the parking position and the passing of a common entrance. In the multi-family house, the first card for vehicle entrance/unparking has information on the household vehicle, and the second card for the passing of the common entrance uses vehicle registration number, sex, name, other personal information stored therein, or uses the information on the vehicle registration number, the sex, the name, the street address, the mobile wireless terminal number stored in the parking management server 30 and at each household. The information includes information on the parking area 26 sectioned for parking convenience and position confirmation. One parking position card reader 22 is installed at each parking area 26. When the vehicle enters the entrance gate 18, the first card installed at the vehicle transmits the entrance information to the parking management server 30 through the entrance reader 14. After the driver parks the vehicle at the parking lot 26, he/she approaches or contacts the second card, such as the proximity RF card or tag card provided for each household constituent, with the parking position card reader 22 installed at the parking area 24. If so, the second card reads recorded information from the parking position card reader 22 and transmits the parking position and the driver information to the parking management server 30. Thus, the parking management server 30 transmits the driver information and the parking position information to the home network management server 12 and the Web server 46. The home network management server 12 receives the driver information and the parking position information, transmits the received information to the plurality of household equipments 10 or a displayable videophone, and displays the parking position information. The Web server 46 connects the parking lot and vehicle management server 60 through the communication network 36. When the vehicle is entered, unparked or parked, the Web server 46 receives the entrance/unparking and parking information from the parking management server 30, and generates the short message data relating to the vehicle position or driver information to transmit the generated data to the SMS generation and transmission server 34. The SMS generation and transmission server 34 transmits the SMS message for the parking position information and the vehicle driver information to the mobile communication provider system 38. The mobile communication provider system 38 displays the SMS message of the parking position information and the vehicle driver information on the plurality of mobile communication terminals 42, 43, and 44 through the base station 40. Here, the plurality of household equipments 10 can also employ the wall pad installed in the household, or the displayable videophone. At this time, the entrance reader 14 and the parking position card reader 22 can be used to identify any whom of the house hold vehicle co-owners is the driver, on the basis of primary and secondary information through card information. Here, the home network management server 12 can be used for gas control, anticrime, disaster prevention, an energy management control using an Internet network for a variety of home appliances, a boiler and an air conditioner, a control of a remote Home shopping, a remote education and a remote medicine, and a control of a kitchen device. The home network management server 12 can communicate with the wall pad installed at each household, and can communicate with the parking management server 30 to transmit the vehicle position information to the wall pad.

However, in case where after receiving the entrance information from the entrance reader 14, the first card does not receive a second card read signal from the parking position card reader 22 within a predetermined time, the parking management server 30 transmits the entrance information to the home network management server 12 and the SMS generation and transmission server 34. Thus, the home network management server 12 receives the entrance information, and transmits the received entrance information toe the plurality of household equipment 10 or the displayable video phone, thereby displaying the entrance information. The Web server 46 receives the entrance/unparking information from the parking management server 30 through the communication network 36 at the time of entrance, generates the short message data relating to the vehicle unparking information, and transmits the generated data to the SMS generation and transmission server 34. The SMS generation and transmission server 34 transmits the SMS message for the unparking information to the mobile communication provider system 38. The mobile communication provider system 38 displays the SMS message of the entrance information on each of the plurality of mobile communication terminals 42, 43, and 44 through the base station 40.

Further, at the time of unparking, assuming that third information defines information obtained from the exit reader 16 installed at the development exit or the parking lot exit, the unparking information is displayed on a corresponding one of the plurality of household equipments 10 or the SMS message is transmitted to each of the mobile wireless terminals 42, 43 and 44 of constituents of the corresponding household so that the vehicle co-owners can recognize the unparking information.

If it is embodied that in a multi-family house apartment, the parking management server 30 and one second card associated with unmanned safety common entrance (not shown) can be used to check the vehicle position or the unparking information, the entrance gate 18 is installed at the development entrance, and the second card recognizes the entrance through the entrance reader 14, the second card read information is transmitted to the parking management server 30 to check the registration or not of the vehicle and open and close the entrance gate 18. If the vehicle is parked at the sectioned park area 24, and the proximity RF card or the contact card approaches the parking card reader 22 positioned within the parking area 24, the parking management server 30 senses and transmits the entrance information and the parking information to the SMS generation and transmission server 34 and the home network management server 12. Thus, the home network management server 12 can display the parking information and the driver information or the unparking information through the wall pad or the displayable video phone and concurrently, transmits and displays the SMS message each of the mobile wireless terminals 42, 43 and 44 of vehicle co-owners. At this time, the parking management server 30 transmits the information to the Web server 46 connected to the communication network 36 such as Internet, the SMS generation and transmission server 34 can transmit the parking information and the driver information or the unparking information to the vehicle co-owner through the mobile communication provider system 38. Accordingly, when the vehicle co-owner exists inside or outside of the household anytime and anywhere, the SMS information of the household wall pad and the mobile wireless terminals 42, 43, and 44 can be used to recognize the position information of the vehicle. At this time, a transmission medium of the vehicle position information can be a card or tag. This can become a card for both the vehicle and the unmanned safety of the multi-family house. Through the transmitted information, even when, after parking, one of the vehicle co-owners searches for the parked vehicle after a few days, he/she can know the parking area of the last driver through the SMS reception message of the wall pad or the mobile wireless terminals 42, 43 and 44 of the household.

Further, even when unparking, the exit reader 16 reads the stored information from the first card installed at the vehicle and transmits the information to the parking management server 30, thereby making it possible to open and close the gate depending on existence of the gate. When the exit reader 16 transmits the unparking information to the parking management server 30, the parking management server 30 opens the exit gate 20, and transmits the vehicle unparking information to the home network management server 12 and the Web server 46, thereby displaying the unparking information on the corresponding one of the plurality of household equipments 10 or the displayable video phone or displaying the SMS message of the unparking information and the driver information on the mobile wireless terminals 42, 43 and 44 of the previously registered household constituents.

Here, the first card comprised of the long distance RF card or the tag card includes only the vehicle unparking information, and the second card comprised of the proximity RF card or the contact second card is possessed by the personal vehicle co-owner so that information on the person of the vehicle co-owner can be transmitted through the card information as to whether who unparks the vehicle. As such, the vehicle position information can be recognized in the multi-family house and therefore, the parking information at a basement parking lot can be shared anytime and anywhere through the household equipment 10, thereby making it possible for the vehicle co-owners to detect the parking position. Therefore, the vehicle position can be appreciated at the basement parking lot and accordingly, it is not required to inquire between the vehicle co-owners via a phone or directly search for the vehicle position as to whether who parks at any area. Further, even at the time of unparking, the vehicle co-owner can recognize the vehicle information within the household through a device being capable of displaying the vehicle position information or the mobile wireless terminals 42, 43 and 44. In recent years, when the vehicle is stolen at the basement parking lot, the vehicle co-owner can recognize the vehicle unparking information inside or outside of the household anywhere without temporary and spatial limit. Therefore, an instant action to the vehicle theft accident can be taken, thereby making it possible to set a countermeasure to the vehicle theft.

FIG. 2 is the control flowchart of the parking management server 30 of FIG. 1, and FIG. 3 is the control flowchart of the home network management server 12 of FIG. 1.

FIG. 4 is the example of the message displayed on the household equipment 10 and the mobile wireless terminals 42, 43 and 44 when the vehicle is entered/unparked and parked.

An operation of the parking management system according to a preferred embodiment of the present invention will be in detail described with reference to FIGS. 1 to 3.

First, if the vehicle arrives at the entrance of the parking lot, the entrance reader 14 reads the information from the first card of the vehicle, and transmits the read information to the parking management server 30. Thus, in Step 101, it is determined whether or not the parking management server 30 receives the card read information from the entrance reader 14. If it is determined that the card read information is received, Step 102 is performed. In the Step 102, the parking management server 30 determines whether or not the card is the registered card. If it is determined that the card is not the registered card, the Step 101 returns. Otherwise, Step 103 is performed. In the Step 103, the parking management server 30 controls and opens the entrance gate 18. If the entrance gate 18 is opened, the driver drives the vehicle into the parking lot. The basement parking lot is divided into several parking areas 24, and the parking area 24 can be divided into several areas such as P1, P2, . . . , P10, for example. After the entrance gate 18 is opened, the parking management server 30 determines whether or not a predetermined time (for example, five minutes) lapses in Step 104. If the time does not lapse, Step 105 is performed. Otherwise, Step 107 is performed. In the Step 107, the parking management server 30 senses and transmits the entrance information, the parking information and the driver information to the Web server 46 and the home network management server 12. Thus, the home network management sever 12 can display the entrance information in the household through the wall pad being the household equipment 10 or the displayable videophone.

At this time, the Web server 46 receives the entrance information from the parking management server 30 through the communication network 36 at the time of entrance, and generates the short message data relating to the vehicle entrance information, and transmits the generated data to the SMS generation and transmission server 34. The SMS generation and transmission server 34 transmits the SMS message of the entrance information to the mobile communication provider system 38. The mobile communication provider system 38 transmits and displays the entrance information on each the mobile wireless terminals 42, 43, and 44 through the base station 40. Accordingly, Accordingly, when the vehicle co-owner exists inside or outside of the household anytime and anywhere, the SMS information of the household wall pad and the mobile wireless terminals 42, 43, and 44 can be used to recognize the position information of the vehicle.

However, if, after passing through the entrance gate 18 and entering and completing the corresponding parking area 24 of the parking lot, the driver contacts his/her possessing second card with the parking position card reader 22, the read parking position information is transmitted to the parking management server 30. At this time, in Step 105, the parking management server 30 determines whether or not the card read information is received form the parking position card reader 22. If it is determined that the information is not received, the Step 104 returns. Otherwise, Step 106 is performed. In the Step 106, the parking management server 30 transmits the read parking position information to the home network management server 12 and the Web server 46. Thus, in Step 201, the home network management server 12 determines whether or not the parking position information is received from the parking management server 30. If it is determined that the parking position information is received, Step 202 is performed, thereby transmitting the parking position information to the corresponding one of the plurality of household equipment 10 and displaying the parking position information on a displaying unit of the household equipment 10.

Further, when the parking position information is received form the parking management server 30, the Web server 46 receives the parking position information and the driver information from the parking management server 30 through the communication network 36, and generates the short message data relating to the parking position information and the driver information, and transmits the generated data to the SMS generation and transmission server 34. The SMS generation and transmission server 34 transmits the SMS message of the parking position information and the driver information to the mobile communication provider system 38, and displays the SMS message on the mobile wireless terminals 42, 43 and 44 of the previously registered vehicle co-owners.

For example, the parking position information can be a message of “Vehicle registration number of Seoul 3 Tu 2345 has been parked at parking area of A-a1-P1”. Here, “A” denotes the first card of the corresponding household, the first card having vehicle information. “a1” can denote a husband, “a2” a wife, and “a3” a son. At this time, when the household equipment 10 has a chip for a voice synthesis process, the parking position information can be also transmitted through the speaker of the household equipment 10 in voice. If, in such a state where the entrance information is not read from the entrance reader 14, the parking position card reader 22 reads from the second card of a specific household, the parking position information is not transmitted and treated as error.

An operation of displaying the unparking information when the parked vehicle is unparked from the parking lot will be described.

In the Step 101, if the second card is not read from the entrance reader 14, the Step is performed to determine whether or not the second card is read from the parking position card reader 22. If it is determined that the second card is read, the Step 109 is performed. In the Step 109, the parking management server 30 determines whether or not the first card of the vehicle is read from the exit reader 22. If it is determined that the first card is read, the Step 110 is performed. In the Step 110, the parking management server 30 determines whether or not the first card is the registered card. If it is determined not to be the registered card, the Step 101 returns. Otherwise, the Step 111 is performed. In the Step 111, the parking management server 30 controls and opens the exit gate 20. After that, in the Step 112, the parking management server 30 transmits the vehicle unparking information to the home network management server 12 and the Web server 46.

Thus, in the Step 203, the home network management server 12 determines whether or not the unparking information is received form the parking management server 30. If so, the Step 204 is performed, thereby transmitting the unparking information to the corresponding one of the plurality of household equipments 10 and displaying “A-a1” on the displaying unit of the household equipments 10.

Further, if the unparking information is received form the parking management server 30, the Web server 46 receives the entrance information form the parking management server 30 through the communication network 36 at the time of unparking, and generates and transmits the short message data relating to the vehicle unparking information, to the SMS generation and transmission server 34. The SMS generation and transmission server 34 transmits the SMS message of the unparking information to the mobile communication provider system 38, and displays the SMS message on the mobile wireless terminals 42, 43 and 44 of the previously registered vehicle co-owners. At this time, the unparking information can be a message “A-a1” as shown in FIG. 4, for example. “A” denotes the first card of the corresponding household vehicle and having the vehicle information, and “a1” denotes the husband. At this time, if the household equipment 10 has the chip for the voice synthesis process, the unparking information can be also transmitted through the speaker of the household equipment 10 in voice. At this time, if all drivers stay in the household and do not drive the vehicle, and the unparking information is displayed, it is determined that the vehicle is stolen. Here, when the parking information or the unparking information is displayed, an alarm sound can be also generated, thereby alarming a state of displaying the parking information and the unparking information.

If it is determined that the second card is not read from the parking position card reader 22 in the Step 108, the Step 113 is performed. In the Step 13, the parking management server 30 determines whether or not the first card of the vehicle is read from the unparking reader 22. If it is determined that the first card is read, the Step 114 is performed. In the Step 114, the parking management server 30 determines whether or not the first card is the registered card. If so, the Step 101 returns. Otherwise, the Step 115 is performed. In the Step 115, the parking management server 30 controls and opens the exit gate 20. After that, in the Step 116, the parking management server 30 transmits the vehicle unparking information to the home network management server 12 and the Web server 46.

Thus, in the Step 203, the home network management server 12 determines whether or not the unparking information is received from the parking management server 30. If the unparking information is received, the Step 204 is performed, thereby transmitting the unparking information to the corresponding one of the plurality of household equipment 10 and displaying “A” on the displaying unit of the household equipment 10.

Further, if the unparking information is received from the parking management server 30, the Web server 46 receives the entrance information form the parking management server 30 through the communication network 36 at the time of unparking, and generates and transmits the short message data relating to the vehicle unparking information, to the SMS generation and transmission server 34. The SMS generation and transmission server 34 transmits the SMS message of the unparking information to the mobile communication provider system 38, and displays the SMS message on the mobile wireless terminals 42, 43 and 44 of the previously registered vehicle co-owners. At this time, the unparking information can be a message “A-a1” as shown in FIG. 4, for example. “A” denotes the first card of the corresponding household vehicle and having the vehicle information, and “a1” denotes the husband. At this time, if the household equipment 10 has the chip for the voice synthesis process, the unparking information can be also transmitted through the speaker of the household equipment 10 in voice. At this time, if all drivers stay in the household and do not drive the vehicle, and the unparking information is displayed, it is determined that the vehicle is stolen.

In case where the vehicle is parked or unparked from the parking lot, the parking position information or the unparking information is displayed on the household equipment 10 and then, after the lapse of a predetermined time, the displayed information is deleted. At this time, the vehicle co-owner presses a parking confirmation key provided at the household equipment 10 so as to identify the parking position. Thus, in the Step 205, the home network management server 12 determines whether or not the parking confirmation key provided at the corresponding household equipment 10 is pressed. If it is determined that the parking confirmation key is pressed, the Step 206 is performed. In the Step 206, the home network management server 12 transmits the parking information or the unparking information finally displayed, to the household equipment 10, and displays the transmitted information on the displaying unit of the wall pad. Thus, the vehicle co-owner detects the vehicle position to identify the parking position information or the unparking information displayed on the displaying unit of the household equipment 10.

In one exemplary embodiment of the present invention, the parking position information or the unparking information can be displayed as the SMS message through the mobile wireless terminals 42, 43 and 44, and be recognized between the vehicle co-owners. However, it is applicable within a scope of the present invention that, when the parking management server 30 transmits the parking position information and the unparking information to the mobile communication provider system 38 through the communication network 36, the mobile communication provider system 38 transmits a message for identifying a Unified Message Switch (UMS) message (or multimedia message), through the base station 40 to allow the vehicle co-owners to recognize the parking position information and the unparking information.

In the exemplary embodiment of the present invention, the parking position information, the driver information and the unparking information is displayed on the mobile wireless terminals 42, 43 and 44, but when the vehicle enters the parking lot, only the entrance information representing that the vehicle enters the parking lot can be also displayed on the household equipment 10 or the mobile wireless terminals 42, 43 and 44, and when the vehicle is unparked outside from the parking lot, only the unparking information can be displayed, and when the driver approaches or contacts his/her owning second card with the parking position card reader installed at the parking lot, to unpark the vehicle outside from the parking lot, the unparking information can be also, together with the driver information, displayed on the household equipment 10 or the mobile wireless terminals 42, 43 and 44.

In the exemplary embodiment, the parking management server 30 transmits the entrance/unparking or parking position and driver information to the Web server 46 through the communication network 36, but it is applicable within the scope of the present invention that the information is directly transmitted to the SMS generation and transmission server 34 and transmitted to the mobile communication provider system 38.

As described above, the present invention has an advantage in that, in case where the vehicle enters the entrance of the parking lot and the RF card is brought into contact with the card reader, thereby opening the exit gate, and the vehicle enters the parking lot, is parked at the corresponding parking area, and contacts the second card with the parking position card reader installed at the parking area where the vehicle is parked, the parking position information and the driver information are displayed on the displaying unit of the household equipment terminal of the home network system, or are displayed on the displaying unit of the previously registered mobile wireless terminal in a format of the SMS message so that the vehicle co-owners can recognize the vehicle parking position, and in case where the vehicle co-owners cannot memorize the parking position, he/she can press the parking confirmation key provided at the terminal of the household equipment to display the parking position on the displaying unit or identify the SMS message received at the mobile wireless terminal, thereby searching the parking position of the parked vehicle anytime.

Further, the present invention has an advantage in that in case where the driver move the parked vehicle to the exit of the parking lot and contacts the second card with the card reader, thereby opening the exit gate and unparking the vehicle outside from the parking lot, the unparking information is displayed on the displaying unit of the household equipment of the home network system or is displayed on the previously registered mobile wireless terminals of the vehicle co-owners so that the vehicle co-owners can recognize the unparking information, and at this time, when no one of the household constituents unparks the vehicle, it is presumed that an outsider unparks the vehicle and the vehicle theft can be detected within the household or outside anywhere.

While the present invention has been described with reference to exemplary embodiments thereof, it will be apparent to those skilled in the art that various modifications can be made therein without departing from the spirit and scope of the invention as defined by the appended claims and their equivalents.

1. A system for identifying vehicle position information, the system comprising:
a plurality of household equipments for, when a vehicle enters a multi-family house development and parks at a parking lot, displaying parking position information, and when the parked vehicle is unparked outside from the multi-family house development, displaying vehicle unparking information;
a home network management server connected with the plurality of household equipments, and notifying the plurality of household equipments of the parking position information and the unparking information of the parked vehicle;
an entrance reader for, when the vehicle enters, recognizing a first card disposed in the vehicle;
an exit reader for, when the vehicle is unparked, recognizing the first card disposed in the vehicle;
a parking position card reader installed at each parking area, which is sectioned in plural, of the parking lot, and when a driver approaches or contacts his/her possessing second card, reading information from the second card and transmitting the parking position information and driver information from the vehicle;
a parking management server for receiving first card read information from the entrance reader, receiving the parking position information and the driver information of the corresponding vehicle from the parking position card reader installed at a corresponding parking area, and transmitting the received parking position information and driver information to the home network management server or a SMS (Short Message Service) generation and transmission server;
a Web server connected to the parking management server, and receiving the parking position and driver information from the parking management server and generating SMS data; and
the SMS generation and transmission server connected with the Web server, and when it is requested to send the SMS data, transmitting and displaying a message relating to the parking position and driver information, on each mobile wireless terminal of the vehicle co-owners.

2. The system according to claim 1, further comprising a parking management terminal connected to the parking management server, and registering information on a vehicle registration number, a sex, a name, and a street address of each household and storing the registered information in the second card.

3-5. (canceled)

6. A method for identifying vehicle position information, the method comprising the steps of:
when a vehicle enters, reading vehicle relation information from a first card installed at the vehicle;
reading vehicle relation information and parking position information from second cards provided for multi-family house vehicle co-owners;
generating a message of vehicle parking position and driver information in response to the vehicle relation information; and
transmitting and displaying the generated message on a household equipment of a home network management server installed at a multi-family house.

7. A method for identifying vehicle position information, the method comprising the steps of:
when a vehicle enters, reading vehicle relation information from a first card installed at the vehicle;
reading parking position information and driver information from second cards provided for multi-family house vehicle co-owners;
generating a SMS message of the parking position information and the driver information; and
transmitting the generated SMS message to a mobile communication provider, and displaying the SMS message on each previously registered mobile wireless terminal of the vehicle co-owners.

8. The method according to claim 7, further comprising the steps of:
when the vehicle is unparked, reading the vehicle relation information from the first card; and
generating a SMS message of vehicle unparking information in response to the vehicle relation information, transmitting the generated SMS message to a mobile communication provider system, and displaying the SMS message on each mobile communication terminal of the vehicle co-owners.

9-10. (canceled)
